(19) United States
(12) Patent Application Publication
(10) Pub. No.: US 2024/0164557 A1
(43) Pub. Date: May 23, 2024

(54) FLAVORING RESERVOIR FOR STORING AROMATICS, METHOD FOR PRODUCING SAME, AND DRINK SYSTEM HAVING SUCH A FLAVORING RESERVOIR

(71) Applicant: AUGUST TÖPFER & CO. (GMBH & CO.), Hamburg (DE)

(72) Inventor: Rudolf Ernst, Hamburg (DE)

(73) Assignee: air up group GmbH, Munich (DE)

(21) Appl. No.: 18/280,933

(22) PCT Filed: Mar. 4, 2022
(86) PCT No.: PCT/EP2022/055592

§ 371 Date: Sep. 7, 2023

(30) Foreign Application Priority Data
Mar. 8, 2021 (DE) 10 2021 105 519.9

(51) Int. Cl. A47G 19/22; A23L 2/56; A23L 27/00

(52) U.S. Cl. CPC A47G 19/2227; A23L 2/56; A23L 27/72; A47G 2400/04

(57) ABSTRACT

A flavoring reservoir for storing aromatics and for releasing the aromatics to a drink system. This flavoring reservoir comprises a container which has a wall that encloses a receiving space. The wall has at least one air inlet opening and at least one air outlet opening. The flavoring reservoir further comprises a substrate material arranged in the receiving space, which material is loaded with an aromatic and releases the aromatic to air that flows in through the air inlet opening, flows past the substrate material and flows out through the air outlet opening. The substrate material is a storage material in the form of a porous or micro-porous granulated material. A method is provided for producing the flavoring reservoir. A drink system is provided having a drink vessel and a flavoring reservoir that is assigned to that vessel and is connected or can be connected to the drink vessel.

Drink vessels and drink systems are known from the prior art in which the user is given a taste experience by means of so-called retronasal olfaction when drinking a beverage that is in itself tasteless, such as in particular pure drinking water, mineral water or tap water. For this purpose, drink vessels, such as drink bottles, are provided with an aroma body, flavoring container or flavoring reservoir from which flavorings are released and conveyed to the user's pharynx during drinking, where they trigger the taste experience.

Such a drink system is available on the market, for example, in the form of the drink system offered by the German company air up GmbH under the air up® brand (cf. www.air-up.com). This drink system consists of a specially shaped drink bottle and interchangeable flavoring reservoirs fitted to the bottle, referred to by the supplier as “pods”, which release a flavor or aroma when the drink system is used so as to trigger a taste experience when drinking water in particular. The manufacturer offers pods with different aromas referred to as “flavors”, for example raspberry, lemon, cherry, cucumber, etc.

Disclosures relating to this prior art and to such drink systems can also be found in the patent literature. Reference is made here to, for example, DE 20 2016 004 961 U1, DE 20 2017 000 239 U1, DE 10 2018 000 382 U1, DE 10 2018 003 669 A1 and DE 10 2018 222 299 A1.

All previously known systems have in common that flavorings, typically in the form of flavors dissolved in water or alcohol, must be introduced into the drinking process and that these must be stored beforehand in a corresponding repository, for example in a flavoring container or flavoring reservoir, which then serves for releasing them.

In the prior art, immediately before being introduced into the flavoring reservoir, the liquid aromatic is sprinkled onto a composite material of synthetic fleece, filter paper and cellulose fibers. All three components have the property of being fiber materials. The aromatic liquid is stored by wetting the outside of the fibers. The main advantage of such systems based on fiber wetting is that they are quick and cheap to produce. The time between sprinkling the fiber materials and their containment in the closed flavoring reservoirs is usually only seconds or a few minutes. However, a major problem with this approach is that such systems are comparatively unstable because the mobility of the aromatic substance on the surface of the storage fibers is unlimited. In particular, warming of the flavoring reservoir can greatly increase the mobility of the aromatic substances, which can lead to overdosing during the subsequent drinking process. Such overheating is relevant in practice when such a drink bottle is left in a car in summer, for example. In the prior art, the migration risk of concentrated aromatics limits the possible loading of the carrier material with aromatics.

In the known system according to the prior art, fragrancing of the conveyed air takes place mainly on the surface of the fiber composite. Due to bypassing, hardly any air flows through the actual, for example rectangular, fiber body, because the fiber body has very high internal air resistance. The absorption of aromatics from the aspirated air takes place mainly on the surface of the fiber body. Most of the fiber surface, that is to say, the interior of the fiber body, is not actively involved in releasing the aromatic to the passing air, but only serves as a store for the aromatic. The liquid aromatics that wet the fibers inside the fiber body migrate to the outside of the fiber body and only fragrance the passing air when they arrive there. The reactive contact area is therefore comparatively small, especially in relation to the stored amount of aromatic and in relation to the volume of the aromatic container. The small reactive contact area means that the olfactory experience is comparatively low in relation to the amount of aromatic used.

Based on this prior art, it is the object of the invention to create an aromatic delivery system for drink systems that is able to provide a better fragrance and drinking experience.

This object is solved by a flavoring reservoir for storing aromatics and for releasing the aromatics to a drink system with the features of claim 1. Further embodiments of such a flavoring reservoir according to the invention which have been recognized as advantageous are described in more detail in claims 2 to 10. In another aspect, the invention discloses a method of manufacturing a flavoring reservoir for storing aromatics and for delivering the aromatics to a drink system, as defined in claim 11. Advantageous further embodiments of the method are described in claims 12 to 19. Finally, a further aspect of the solution of this object according to the invention lies in a drink system having the features of claim 20.

A flavoring reservoir according to the invention for storing aromatics and for releasing the aromatics to a drink system firstly comprises a container. This container has a wall that encloses a receiving space, in which at least one air inlet opening and at least one air outlet opening are provided. Advantageously, this container may be configured in such a way that the flow velocity of the air passing through it is as high as possible. For this purpose, the cross-section of the container is advantageously chosen so that it preferably has a diameter/length ratio of 5:1 or more in relation to a length through which air flows. In particular, the container can also be made of a material that is obtained from renewable raw materials and/or is recyclable or compostable. For example, the container can be made of cork or a plastic derived from plant material.

The flavoring reservoir further comprises a substrate material arranged in the receiving space, which material is loaded with an aromatic and releases the aromatic to air that flows in through the air inlet opening, flows past the substrate material and flows out through the air outlet opening. What is special about this flavoring reservoir is, generally, that the substrate material is a storage material in the form of a porous or micro-porous granulated material.

The use of a porous or micro-porous granulated material according to the invention instead of a fleece fabric as used in the prior art allows the liquid aromatic to be stored by migration in the porous or micro-porous storage material and the aromatic to be adsorbed on inner surfaces in the pores of the storage material, and thus enables far higher loading of the storage material with the aromatic or aromatics. A prerequisite is, of course, that the storage material does not react with the aromatic, but merely stores it and then releases it again. The pore structure of the granules must also be open-pored, that is to say, the inner pores must be accessible for migration of the aromatic from the outer surface of the granules. A porous granulated material used according to the invention is characterized in particular by the aforementioned inner surface, namely the surface of the pores or micro-pores located inside the granules. The pore size of the granules is selected to match the molecular size of the aromatic used. If the pores are too small in relation to the size of the molecules of the aromatic used, the aromatic will not migrate into the granules. Conversely, if the pores are too large in relation to the size of the molecules of the aromatic used, on the one hand insufficient storage surface will be available and on the other hand the aromatic will be released again too quickly and uncontrollably.

The use of granules for storing aromatics also has the important advantage that the effective outer surface area from which the aromatic is released into the passing air is significantly larger, in particular by between 200% and 1000%, than the surface area of fleeces relative to the given container volume.

Air will flow through the granules if the container is suitably designed because, due to their free-flowing nature, the granules fill the container very effectively as far as the walls. This means that any large air gaps will be closed and air must flow through the granules. Since the air gaps within the granulated material are very small, the flow velocity is increased in these gaps, which promotes the evaporation of the aromatics. Fleeces do not normally have air flowing through them; the air flows past the fleece. Therefore, the air is fragranced only on the outside of the fleece package. Spent aromatic is replaced by migration from the inside of the fleece to the outside.

By using a porous or micro-porous granulated material according to the invention, it is possible to offer the user of a drink system provided with the flavoring reservoir a uniform olfactory experience for as long as the aromatic refill (of the aroma reservoir) lasts.

This is due to the aromatic migrating into the pores or micro-pores of the granules. Thus, at the start of use, the vapor pressure of the aromatic, being mainly adsorbed on the inner surfaces of the granules, is so low that it is released in lower concentrations compared to mainly surface adsorption on a fleece material. Users of a drink system provided with the flavoring container then have an intense olfactory experience and believe they are drinking a soft drink. However, the aromatic content of the air aspirated during drinking is so low that the user cannot become sensitized by the fragrance.

Because the aromatic is incorporated into the pores or micro-pores and migrates to the outer surface of the granules over the course of use, the vapor pressure of the aromatic remains similar to what it was at the start of use, so that even if the flavoring container is already significantly discharged and has been used for a prolonged period of time, the user has a largely constant, intensive olfactory experience. In the granules used according to the invention, the evaporation rate of the aromatic, and thus the user's olfactory experience, does not depend on the area occupied, but rather on the size of the openings of the pores and channels, and thus changes only slightly during use.

In the case of a fleece as used in the prior art, on the other hand, the adsorbing surface area is small and the intensity of the olfactory experience diminishes noticeably as the adsorbed amount decreases. If the fleece has been freshly sprinkled with aromatic, or if the flavoring reservoir containing such a fleece has been freshly opened, the user will have an overwhelming olfactory experience. Towards the end, however, when the supply is almost used up, the olfactory experience is significantly weaker due to the decreasing vapor pressure, which is unsatisfactory.

Where the aromatics used are essential oils or fragrance oils, it has been found that the best incorporation results can be achieved with granules having hydrophobic and lipophilic surfaces. However, it is also possible to use water-based products, which may then require a different type of granule.

Ideal granules for storing the aromatics described above include, among others, polymers or copolymers, either of plant origin, in which case cork has proven to be particularly suitable, or those having a synthetic, in particular petrochemical, basis, such as an inhomogeneous crystalline copolymer of ethylene vinyl acetate (EVA) and polyethylene (PE). Very good results are achieved with copolymers of EVA and PE whose EVA content is 10 to 50% by weight, in particular 20 to 40% by weight. For the absorption of essential oils, such as lemon oil or lime oil, a copolymer of EVA and PE has proven to be particularly suitable, with an EVA content of approximately 30% by weight, in particular 28% by weight. As a general rule, the fragrance storage capacity rises with increasing EVA content. However, with an EVA content significantly above 50%, the consistency of the copolymer becomes rubbery, which impairs the stability and use of the granules loaded with the aromatic. With an EVA content below 10%, the aromatic absorption capacity decreases significantly and may then no longer be sufficient. EVA/PE copolymers can be loaded with aromatics in a ratio of up to 30% by weight. Incorporation of the aromatics into the granules is intercrystalline. The EVA/PE copolymer granules must therefore be an inhomogeneous crystal mixture and must not be melted during the manufacturing process to such an extent that a homogeneous mixed crystal is produced.

Very good results have been achieved within the scope of the invention using cork granules. Cork is a water-impermeable lipophilic biopolymer. The air-filled, dead cork cells form a natural hard foam. Cork can absorb aromatics in a ratio of more than 50% by weight and release them uniformly. If cork or another natural, in particular plant-based, material is used as storage material, it can be treated beforehand to reduce or eliminate microbiological contamination of the material. Such treatment can be carried out, for example, thermally. It is also advantageous to wash out tannic acids from the cork insofar as they have been incorporated into it by the cork-producing plant, because tannic acids can potentially attack the aromatics that are to be incorporated into the cork.

It is also possible in principle to use inorganic granules which are porous and, for example, non-polar or lipophilic. For example, bentonite or clay granules, in particular smectite clay, can be used.

However, inorganic granules have a tendency to generate fine dust through mechanical abrasion, which must not be allowed to enter the human respiratory tract unfiltered. Therefore, in this case special measures are required to keep this fine dust safely out of the air provided with aromatics by means of the flavoring reservoir according to the invention. The aromatics are incorporated into the granules, in particular into the pores of the granules, by migration, which in turn is based on capillary effects. Migration is promoted by placing the aromatic and carrier material in a closed container, resulting in a high concentration or vapor pressure of the volatile aromatic in the atmosphere of the closed container. The release of the stored aromatics is based on the same mechanism, but in the opposite direction. In this case, fresh, unfragranced air is led past the granules so that the vapor pressure of the liquid aromatic acts in the opposite direction.

The storage material in the form of porous or micro-porous granules can, in particular, have a grain size of 2 mm to 8 mm, preferably 4 mm to 6 mm. It has been found to be particularly advantageous to remove any fine fraction below 1 mm from the granules by sifting prior to the fragrancing process, because this fine fraction in combination with the liquid aromatics can form a sticky mass that disturbs the process and prevents the production of free-flowing aromatic granules, but rather promotes uncontrolled lump formation. For the user to have a good retronasal olfactory experience when using a drink system equipped with the flavoring reservoir according to the invention, it is important for the flow resistance of the respiratory air during aspiration of the aromatic to be sufficiently low and, moreover, defined. To achieve this, the granular particles should not be too small. The granules should preferably have a minimum size to ensure low flow resistance. The resistance experienced by the air to be loaded with aromatic when flowing through the granules in the flavoring reservoir should not be greater than 1000 Pa, preferably not greater than 500 Pa, more preferably not greater than 200 Pa.

Advantageously, the size of the granules should vary only within a predefined range in order to obtain a uniform flow, a defined flow resistance and uniform loading with and discharge of the fragrance. In particular, granules may be chosen with a particle size such that 95% fall within a size interval of 30%.

A method according to the invention for manufacturing a flavoring reservoir for storing aromatics and for releasing the aromatics to a drink system comprises the following steps:
a. providing a closable, in particular capsule-like, container having a receiving space and a wall that encloses this receiving space, in which at least one air inlet opening and at least one air outlet opening are provided,
b. providing a storage material in the form of a porous or micro-porous granulated material,
c. loading the storage material with one or more aromatics,
d. filling the receiving space with storage material loaded with the aromatic(s),
e. closing the receiving space filled with storage material loaded with the aromatic(s).

According to the invention, the storage material is loaded by migration of the aromatic(s) into the porous or micro-porous granulated material. Migration of the aromatics into the porous granules typically takes place by utilizing the capillary effect. This means that the pore size, the electrochemical properties of the granules and the aromatic to be incorporated must be matched with one another.

As explained above, loading the porous or micro-porous granules with liquid aromatic by migration into the porous or micro-porous storage material allows much higher loading of the storage material with the aromatic(s). To facilitate handling of the granules when they are put into the container, provision can be made to form the granules—before or after loading with the aromatic—into a composite, for example by pressing, sintering or similar measures. However, it is important that the internal pore structure of the granules is maintained and that the pores remain open to the surface of the granules so that the aromatic can migrate from the pores to the surface, or in the opposite direction during loading.

Furthermore, in particular the storage of the liquid aromatics in the storage material can be separated in space and time from the process of packaging the aroma medium in the aroma body. This separation provides more time for the liquid aromatics to penetrate the storage material. As a result, the incorporation of the aromatics into this storage material is more stable, because the underlying physical processes, namely diffusion or migration for incorporation and release, are the same. They essentially operate with the same efficiency in both directions. It results from this that a storage material which can be quickly loaded with aromatic will also release it relatively quickly, or that a storage material which takes longer to load with aromatic will also release it over a longer period of time.

The process of loading the storage material, which is separated in space and time from the packaging of the storage material in the flavoring reservoir, also allows energy to be added to the loading process, either directly, for example by heating the process container, or indirectly, for example by the generation of heat through internal friction in the storage medium when it is moved. In addition, a reaction vessel in which loading takes place may be pressurized, either directly by pressurizing the vessel with a compressed gas, which is another form of energy input, or indirectly through expansion of the input materials as a result of the heating described above. In either case, it is considered advantageous to make the reaction vessel pressure-tight. An energy supply as described above enables the desired one-way effect, namely that whereby the incorporation of the aromatics in the storage medium takes place significantly faster with the supply of energy from outside than the release without energy supply. In addition, much higher stable concentrations of aromatics can be achieved in the storage material, namely 20 to 50% by weight.

In particular, the loading process can take place in a rotating or oscillating mixing vessel, which can be, for example, a pressure-tight mixing drum of a rotary mixer or tumbler. This mixing vessel can advantageously have a smooth inner wall without tools, so it can be, for example, a pressure-tight, toolless mixing drum. This is preferable, because rough tools can damage the granules. The mixing drum to be used is preferably cylindrical, particularly preferably with an ellipsoidal cross-section, and rotates or oscillates about an axis.

The rotational speed or oscillation frequency of the rotating or oscillating mixing vessel can be chosen, in particular, so that the mixed material forms a rotating or oscillating roll inside the mixing vessel. It is preferable in particular to avoid conveying the product to the very top by centrifugal force and allowing it to fall, because this can damage the granules. When using a rotating mixing vessel, the speed is advantageously set from 5 to 15 revolutions per minute (rpm), preferably to 10 rpm.

Preheating of aromatics and/or granules would be desirable, but is hardly practical in practice, since the flash point of most aromatics is low, usually around 45 degrees. Therefore, energy is preferably delivered to the loading process very slowly and very uniformly via the drive of the mixing vessel. Once loading in a rotating or oscillating mixing vessel has ended, the aromatic-loaded granules can then be left to rest to achieve further uptake of aromatic and stabilize the system. Observance of a resting period makes it possible, in particular, to produce stable aromatic granules which are dry on the surface. In the resting phase, the aromatic can enter in particular into the core of the individual granules of the granulated material, that is to say, migrate there.

The process of loading the granules can take place in particular with the following steps:
sifting of fine fraction from the raw granules,
adding the aromatic liquid to the mixing vessel,
adding the granules to the mixing vessel,
mixing with an oscillating or rotating motion, for example rotating at a low speed of, for example, approx. 10 rpm, over a period of, for example, 4 to 6 hours,
resting the mixture in the stationary mixing vessel for 18 to 20 hours,
sifting the finished product to remove material abraded during the mixing process.

If coloring of the storage material is desired, then a powdered dye, for example, can be added to the mixing vessel, in particular before the aromatic liquid is added, or alternatively suspended or dissolved in the liquid aromatic beforehand. As an alternative to the above sequence, the granules can also be added to the mixing vessel before the aromatic, and the aromatic can be continuously injected to avoid lump formation that might disturb the process.

The overall filling level of the mixing vessel should preferably not exceed 35 to 40% of the maximum filling volume of the mixing vessel.

During the resting period, the mixing vessel can be rotated or oscillated at intervals if necessary, for example two to ten times every 10 to 15 minutes, to prevent the loaded storage material from clumping.

With this process it is possible to achieve loading levels of up to 30% and even up to 70% by weight relative to the granules.

If the parameters are correctly chosen, the granules will not form blockages, adhesions or moisture pockets.

There are natural aromatics that must be extracted from the starting material, such as a plant material, using ethanol. An example of this is natural vanilla. Aromatics produced in this way have the disadvantage that a slight alcoholic or chemical note cannot be avoided. Consumers describe this as a “laboratory” or “chemical” odor. To be able to offer such fragrances without the disruptive influence of ethanol, a different approach must be taken: First, the starting material is finely ground. This ground material is then dissolved or suspended in a suitable liquid, such as alcohol or water. This liquid is then applied to a suitable carrier material, ideally granules, in a mechanical mixing process. The carrier liquid is then evaporated or dried off. The finely ground solid-body aromatics are now left adhering to the surface of the granules due to electrochemical interactions. There they develop their aromatic effect when they are placed in the aromatic container.

Finally, a further aspect of the invention relates to a drink system comprising a drink vessel and a flavoring reservoir that is assigned to that vessel and is connected or can be connected to the drink vessel as described above in such a way that, when a person drinks from the drink vessel, air aspirated through the air inlet opening in the wall of the flavoring reservoir and provided with the aromatic stored in the substrate material is guided through the air outlet opening and to the mouth of the drinker.

Possible embodiments for loading a porous or micro-porous granulated material with an aromatic are described below:

### EXAMPLE 1

20 liters of EVA/PE copolymer granules with an average particle size of 5 mm, 28% EVA content and a bulk weight of 11.8 kg were placed in a mixing drum with a capacity of 50 liters and with an ellipsoidal cross-section viewed in parallel with the axis of rotation. The granules were then exposed to a saturated pure lemon oil vapor under pressure. The mixing drum was rotated at 15 rpm for 4 to 6 hours. The mixing drum was then allowed to rest for 15 hours, with stirring at 15 rpm for 10 min every hour to prevent the granules from clumping. The granules were thereafter saturated with the essential oil and ready for use. The granules removed from the drum smelled intensely of lemon.

### EXAMPLE 2

20 liters of dried cork granules with an average particle size of 3 mm and a bulk weight of 3 to 4 kg were placed in a mixing drum with a capacity of 50 liters and with an ellipsoidal cross-section viewed in parallel with the axis of rotation. A liquid natural peach flavoring was then added to the granules. The mixing drum was rotated at 10 rpm for 4 to 6 hours. The mixing drum was then allowed to rest for 15 hours, with stirring at 10 rpm for 15 min every hour to prevent the granules from clumping. The liquid flavoring was thereafter completely absorbed by the granules and the granules were ready for use. The granules removed from the drum smelled intensely of peach.

### EXAMPLE 3

In a fluidized bed dryer with a screen surface of 20 cm diameter, 2.25 liters of EVA/PE copolymer were applied to the screen surface. The granular layer was lifted with an air flow passed through the layer from below. The air was saturated with orange oil and circulated. After half an hour, the granules were saturated with the essential oil and could be removed. The granules smelled intensely of orange.

In all three examples, the granules were carefully sifted after loading with aromatic in order to remove the abraded material that occurs during the described loading process.

Immediately after sifting out the abraded material, the loaded granules were packed into portion bags to prevent loss of fragrance due to storage until the containers were filled to form the flavoring reservoirs, while also being able to store the granules for a longer period if necessary and/or transport them to a different processing location. The material for the portion bags can be, for example, aluminum laminated bags made of plastic or paper.

In the examples described above, the granules were loaded with aromatic at room temperature. However, it may also be advantageous to load the granules at a higher temperature to take advantage of the lower viscosity of aromatics at higher temperatures. On the other hand, the shorter process times should be weighed against the advantage of working below the aromatic's flash point, which is a limit above which it is necessary to use manufacturing equipment of explosion-proof design.

Compared to a mixing drum, a fluidized bed process as described in Example 3 above has the advantage that the granules are subjected to less mechanical stress and therefore, after loading with aromas, have more corners and edges on which the aromatic can be picked up by the passing air and carried further as an aerosol. In particular, aromatics with low vapor pressure, such as vanilla or strawberry, are therefore preferably applied in a fluidized bed.

If granules consisting of thermoplastics, such as EVA/PE copolymer, are loaded with aromatic, the temperature of the loading process should be limited so that no softening of the polymer takes place, as this would lead to a reduction in the internal surface area of the granules.

Manufacturing processes in which the fluidized bed is generated in a rotating or oscillating mixing vessel are also possible.

Furthermore, comparative tests were carried out with identically formed drink systems, once with flavoring reservoirs formed according to the prior art with a fleece wetted with aromatic, and once with flavoring reservoirs formed according to the present invention containing granules loaded with aromatic. A lemon oil was used as aromatic.

Containers like those described in DE202016004961 U1 and DE 102018003669A1 were used as drink containers for the drink system. For the test, use was made, on the one hand, of commercially available flavoring containers as described in utility model DE202016004961 U1, and, on the other hand, flavoring containers in which the fleece contained therein was removed before the start of the test and replaced by granules loaded with aromatic according to the invention.

Five prepared drink systems were used in each case for the test. Without being informed about the type of flavoring reservoir and the difference between the drink systems, five subjects were then given one each of the drink systems provided with the flavoring reservoir formed according to the prior art and one with a flavoring reservoir formed according to the invention. The subjects received a questionnaire in which they were asked to record their sensory impressions. The differently prepared drink systems were identical in terms of their external appearance and design, differing only by a marking which could not be deciphered by the subject and which indicated to the tester whether it was a drink system according to the prior art or one with a flavoring container according to the invention.

Concerning the drink system according to the prior art, all five test subjects reported that, immediately after breaking open the flavoring container, the taste impression was satisfactory when taking the first sips from the drink system, but that the taste sensation diminished considerably over the course of use, so that, by the end of the period of use of the flavoring container, upon filling the bottle for the last time, the taste experience was insipid.

Regarding the drink systems with flavoring reservoirs according to the invention, all test subjects reported that the first taste impression after opening the flavoring reservoir was far more intense, that the olfactory experience diminished less over the course of use and that the experience was positive even upon filling the drink system for the last time. All test subjects reported that the flavoring reservoirs according to the invention conveyed the taste impression of a real soft drink.

1. A flavoring reservoir for storing aromatics and for releasing the aromatics to a drink system, the flavoring reservoir comprising:
a container which has a wall that encloses a receiving space in which at least one air inlet opening and at least one air outlet opening are provided, and
a substrate material arranged in the receiving space, which the substrate material being loaded with an aromatic and releases the aromatic which is releasable to air that flows in through the air inlet opening, flows past the substrate material and flows out through the air outlet opening, characterized in that wherein the substrate material is a storage material in the form of a porous or micro-porous granulated material.

2. The flavoring reservoir according to claim 1, wherein the storage material is a porous or micro-porous granulate made of a hydrophobic and lipophilic material.

3. The flavoring reservoir according to claim 1, wherein the storage material is a porous or micro-porous granulate made of a polymer or copolymer.

4. The flavoring reservoir according to claim 3, wherein the polymer or copolymer is of plant origin, in particular cork.

5. The flavoring reservoir according to claim 3, wherein the polymer or copolymer is of synthetic, in particular petrochemical, origin.

6. The flavoring according to claim 5, wherein the storage material is a copolymer of ethylene vinyl acetate (EVA) and polyethylene (PE).

7. The flavoring reservoir according to claim 6, wherein the proportion of EVA in the copolymer is 10 to 50% by weight, in particular 20 to 40% by weight.

8. The flavoring reservoir according to claim 1, wherein the storage material is an inorganic material in the form of porous or micro-porous granules, in particular granules of aerated concrete, foamed concrete, bentonite, zeolite or porous clay bodies, in particular those of smectite clay.

9. The flavoring reservoir according to claim 1, wherein the granules have a particle size of 2 mm to 8 mm, preferably 4 mm to 6 mm.

10. The flavoring reservoir according to claim 1, wherein the granules have a particle size such that 95% fall within a size interval of 30%.

11. A method of manufacturing a flavoring reservoir, according to claim 1, for storing aromatics and releasing the aromatics to a drink system, the method comprising acts of:
a. providing a closable, in particular capsule-like, container having a receiving space and a wall that encloses the receiving space, in which at least one air inlet opening and at least one air outlet opening are provided,
b. providing a storage material in the form of a porous or micro-porous granulated material,
c. loading the storage material with one or more aromatics,
d. filling the receiving space with storage material loaded with the one or more aromatics,
e. closing the receiving space filled with storage material loaded with the one or more aromatics,
the storage material being loaded by migration of the one or more aromatics into the porous or micro-porous granulated material.

12. The method according to claim 11, wherein the storage medium is loaded in a rotating or oscillating mixing vessel into which the storage medium in the form of porous or micro-porous granules and the aromatic in liquid form are introduced.

13. The method according to claim 12, wherein the mixing vessel has a smooth and toolless inner wall.

14. The method according to claim 12, wherein the rotational speed of the rotating mixing vessel or that the oscillation frequency of the oscillating mixing vessel is chosen such that the mixed material forms a rotating or oscillating roll inside the mixing vessel.

15. The method according to claim 12, wherein a rotating mixing vessel is used, and that the mixing vessel is set to a rotational speed of 5 to 15 rpm.

16. The method according to claim 12, wherein the mixing vessel is allowed to rotate or oscillate for a period of 4 to 6 hours for loading with the one or more aromatics.

17. The method according to claim 12, wherein, after loading in the rotating mixing vessel, the storage material in the form of porous or micro-porous granules loaded with the one or more aromatics is allowed to rest before step d., in particular for a period of 18 to 20 hours and in particular in the mixing vessel.

18. The method according to claim 12, wherein energy is input during loading of the storage medium with the one or more aromatics.

19. The method according to claim 11, wherein the storage material loaded with the one or more aromatics is sifted before act d. in order to separate particles below a definable diameter.

20. A drink system comprising a drink vessel and a flavoring reservoir according to claim 1 that is assigned to the drink vessel and is connected or can be connected to the drink vessel or a flavoring reservoir produced by a method according to claim 11, such that, when a person drinks from the drink vessel, air aspirated through the air inlet opening in the wall of the flavoring reservoir and provided with the aromatic stored in the substrate material is guided through the air outlet opening and to the mouth of the drinker.
